(19) United States
(12) Patent Application Publication
(10) Pub. No.: US 2009/0316703 A1
(43) Pub. Date: Dec. 24, 2009

(54) MODEM SYSTEM AND METHOD

(75) Inventors: JUN SONG, Shenzhen City (CN); SONG GUO, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/470,462

(22) Filed: May 21, 2009

(30) Foreign Application Priority Data
Jun. 19, 2008 (CN) 200810302226.1

(51) Int. Cl. H04L 12/56

(52) U.S. Cl. 370/395.3

(57) ABSTRACT

A modem and communication method between a wide area network (WAN) and a client device receives a communication data packet from the WAN or the client device, and removes a virtual local area network identification (VLAN ID) of the communication data packet in response to a determination that a VLAN ID of the communication data packet does not identify a local area network port of the modem. The modem and communication method further translates an IP address of the communication data packet having no VLAN ID, and transmits the translated communication data packet to the client device or the WAN using a network access translation port of the modem. Furthermore, the modem and communication method transmits the communication data packet containing the VLAN ID to the client device or the WAN using the LAN port.

### BACKGROUND

1. Technical Field

Embodiments of the present disclosure relate to communication methods, and particularly to a modem system and method.

2. Description of Related Art

Modems are devices that translate digital signals into specific frequencies to travel over telephone or cable television lines. Client devices use modems to communicate with one another over a network, such as over a wide area network (WAN). Usually, modems transmit communication data packets between the client devices and the WAN using one or more local area network (LAN) ports. Each communication data packet can be transmitted according to the identification of the communication data packet via a corresponding LAN port of a modem. However, if a communication data packet cannot be identified using the LAN ports of the modem, the communication data packet cannot be transmitted by the modem.

Therefore, there is a need for a system and method to overcome the aforementioned problem.

### BRIEF DESCRIPTION

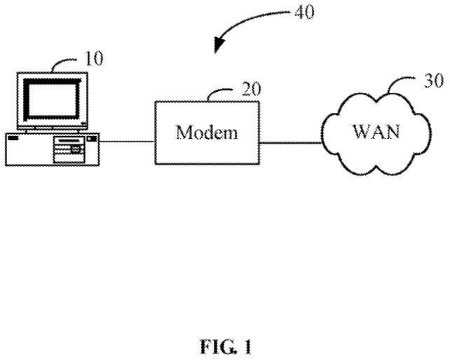

FIG. 1 is a block diagram of one embodiment of a system for showing data communication between a client device and a WAN via a modem.

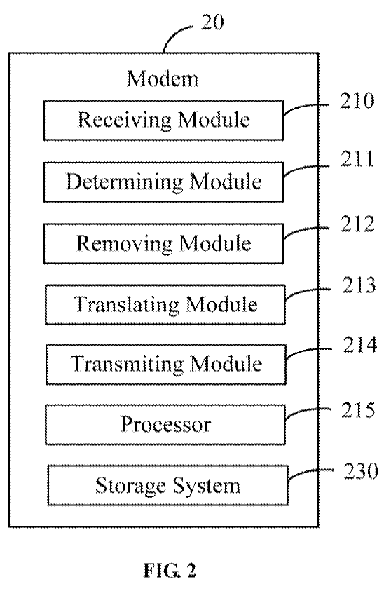

FIG. 2 is a block diagram of one embodiment of the modem of FIG. 1.

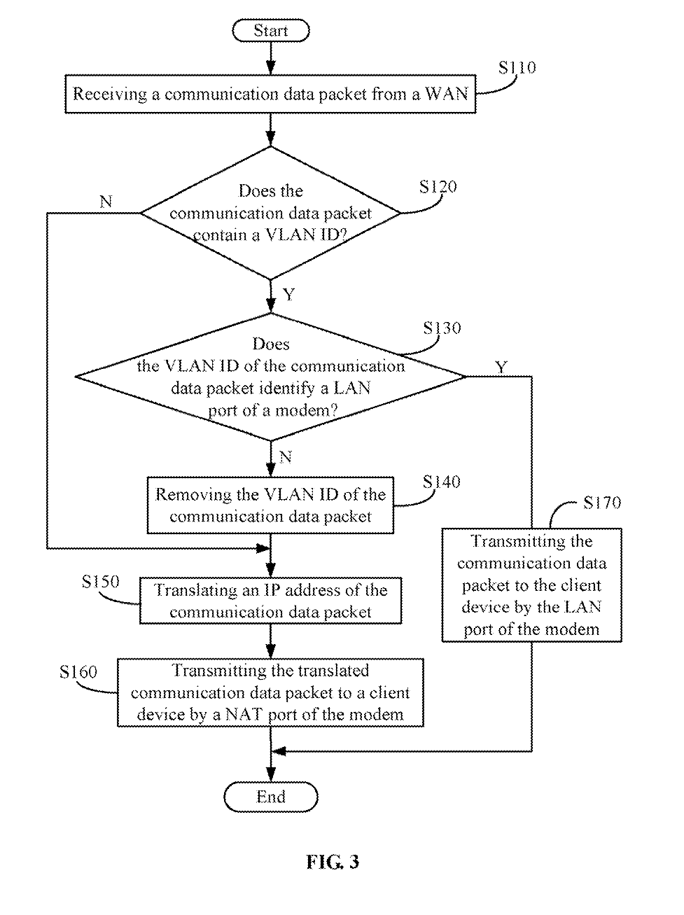

FIG. 3 is a flowchart of one embodiment of a method for exchanging communication data packets from the WAN to the client device via the modem.

### DETAILED DESCRIPTION

All of the processes described below may be embodied in, and fully automated via, function modules executed by one or more general purpose processors. Some or all of the methods may alternatively be embodied in specialized hardware. The code modules may be stored in any type of computer-readable medium or other computer storage device.

FIG. 1 is a block diagram of one embodiment of a system 40 showing data communication between a client device 10 and a wide area network (WAN) 30 via a modem 20. In this embodiment, the system 40 includes one or more client devices 10 (only one shown in FIG. 1), the modem 20, and a WAN 30. The modem 20 is connected to the client device 10 and the WAN 30. It may be understood that, in one embodiment, the WAN 30 may be the Internet. Depending on the embodiment, the client device 10 may be a personal computer (PC), a network server, a hypertext transfer protocol (HTTP) server, a file transfer protocol (FTP) server, or any other appropriate data-processing electronic device.

The modem 20 implements electronic data communication between the client device 10 and the WAN 30. The modem 20 comprises a plurality of local area network (LAN) ports and network access translation (NAT) ports. In one embodiment, the LAN ports are operable to transmit communication data packets having a virtual local area network identification (VLAN ID). In contrast to the LAN ports, the NAT ports are operable to transmit communication data packets in a particular form that can be identified using the NAT ports. Depending on the embodiment, the modem 20 may be an asymmetric digital subscriber line (ADSL) or a symmetric digital subscriber line (SDSL) modem, a cable modem or other appropriate device having modulating and demodulating data functions.

FIG. 2 is a block diagram of one embodiment of the modem 20 of FIG. 1. The modem 20 includes a receiving module 210, a determining module 211, a removing module 212, a translating module 213, and a transmitting module 214. One or more computerized codes of the modules 210-214 are stored in a storage system 230. One or more general purpose or specialized processors, such as a processor 215 executes the computerized codes of the modules 210-214 to provide one or more operations of the modem 20.

The receiving module 210 is operable to receive a communication data packet from the WAN 30 or the client device 10.

The determining module 211 is operable to determine if the communication data packet contains a VLAN ID. It may be understood that, the VLAN ID can identify the LAN port of the modem 20. The VLAN ID is defined by the IEEE 802.1Q standard, in one example. In one embodiment, the VLAN ID is attached to a tag field of the communication data packet. The determining module 211 determines if the communication data packet contains the VLAN ID by determining if the tag field of the communication data packet is void.

The determining module 211 is further operable to determine if the VLAN ID of the communication data packet identifies a LAN port of the modem 20, in response to a determination that the communication data packet contains the VLAN ID. For example, assuming that the modem 20 contains two LAN port A and B, if the VLAN ID of the communication data packet identifies the LAN port A, then the communication data packet is transmitted using the LAN port A of the modem 20.

The removing module 212 is operable to remove the VLAN ID of the communication data packet in response to a determination that the VLAN ID of the communication data packet does not identify the LAN port of the modem 20. In one embodiment, if the communication data packet having the VLAN ID cannot be transmitted using the LAN port of the modem 20, the communication data packet may be transmitted using the NAT port of the modem 20. It may be understood that the communication data packet having a VLAN ID cannot be transmitted using the NAT port directly, so the VLAN ID of the communication data packet should be removed.

The translating module 213 is operable to translate an Internet protocol (IP) address of the communication data packet having no VLAN ID. In one embodiment, the translating module 213 translates the IP address of the communication data packet into a form that the communication data packet having no VLAN ID can be transmitted using the NAT port of the modem 20. In one embodiment, the IP address may be defined according to different classes, such as A class, B class, or C class. For example, if the IP address of the communication data packet is A class or B class, the translating module 213 translates the IP address of the communication data packet into C class, then the translated communication data packet can be transmitted using the NAT port of the modem 20.

The transmitting module 212 is operable to transmit the translated communication data packet using the NAT port of the modem 20, or to transmit the communication data packet having the VLAN ID to the client device 10 or the WAN 30 using the LAN port of the modem 20.

FIG. 3 is a flowchart of one embodiment of a method for exchanging communication data packets between the WAN 30 and the client device 10 via the modem 20. In one embodiment, communication data packet transmission from the WAN 30 to the client device 10 is taken as an example. Communication data packet transmission from the client device 10 to the WAN 30 is a similar process. Depending on the embodiment, additional blocks may be added, others removed, and the ordering of the blocks may be changed.

In block S110, the receiving module 210 receives a communication data packet from the WAN 30.

In block S120, the determining module 211 determines if the communication data packet contains a virtual local area network ID (VLAN ID). As mentioned above, the VLAN ID can identify a LAN port of the modem 20.

If the determining module 211 determines that the communication data packet contains the VLAN ID, the procedure goes to block S130. Otherwise, if the determining module 211 determines that the communication data packet does not contain the VLAN ID, the procedure goes to block S150.

In block S130, the determining module 211 determines if the VLAN ID of the communication data packet identifies a LAN port of the modem 20. As mentioned above, assuming that the modem 20 contains two LAN port A and B, if the VLAN ID of the communication data packet identifies the LAN port A, then the communication data packet is transmitted using the LAN port A of the modem 20.

If the determining module 211 determines the VLAN ID of the communication data packet identifies the LAN port of the modem 20, the procedure goes to block S170, the transmitting module 214 transmits the communication data packet containing the VLAN ID to the client device 10 using the LAN port of the modem 20. Otherwise, if the VLAN ID of the communication data packet does not identify the LAN port of the modem 20, the procedure goes to block S140.

In block S140, the removing module 212 removes the VLAN ID of the communication data packet.

In block S150, the translating module 213 translates an IP address of the communication data packet having no VLAN ID. As mentioned above, the translating module 213 translates the IP address of the communication data packet into a form that the communication data packet can be transmitted using the NAT port of the modem 20.

In block S160, the transmitting module 214 transmits the translated communication data packet to the client device 10 using a NAT port of the modem 20.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A modem in electronic communication between a wide area network (WAN) and a client device, the modem comprising:
a storage system;
at least one processor; and
one or more programs, wherein the one or more programs are stored in the storage system and to be executed by the at least one processor, the one or more programs comprising:
a receiving module operable to receive a communication data packet from the WAN or the client device;
a determining module operable to determine if the communication data packet contains a virtual local area network identification (VLAN ID), and to determine if the VLAN ID of the communication data packet identifies a local area network (LAN) port of the modem in response to a determination that the communication data packet contains the VLAN ID;
a removing module operable to remove the VLAN ID of the communication data packet in response to a determination that the VLAN ID of the communication data packet does not identify the local area network (LAN) port of the modem;
a translating module operable to translate an Internet protocol (IP) address of the communication data packet having no VLAN ID; and
a transmitting module operable to transmit the translated communication data packet using a network access translation (NAT) port of the modem, or to transmit the communication data packet containing the VLAN ID using the LAN port of the modem to the client device or the WAN.

2. The modem of claim 1, wherein the modem is selected from the group consisting of an asymmetric digital subscriber line (ADSL) modem, a symmetric digital subscriber line (SDSL) modem, and a cable modem.

3. The modem of claim 1, wherein the VLAN ID identifies the corresponding LAN port of the modem.

4. The modem of claim 1, wherein the client device is selected from the group consisting of a personal computer (PC), a network server, a hypertext transfer protocol (HTTP) server, and a file transfer protocol (FTP) server.

5. A communication method between a client device and a wide area network (WAN) via a modem, the method comprising:
(a) receiving a communication data packet from the WAN or the client device;
(b) determining if the communication data packet contains a virtual local area network identification (VLAN ID);
(c) determining if the VLAN ID of the communication data packet identifies a local area network (LAN) port of the modem;
(d) transmitting the communication data packet containing the VLAN ID to the client device or the WAN using the LAN port of the modem in response to a determination that the VLAN ID of the communication data packet identifies the local area network (LAN) port of the modem;
(e) removing the VLAN ID of the communication data packet in response to the determination that the VLAN ID of the communication data packet does not identify a local area network (LAN) port of the modem;
(f) translating an Internet protocol (IP) address of the communication data packet having no VLAN ID; and
(g) transmitting the translated communication data packet to the client device or the WAN using a network access translation (NAT) port of the modem.

6. The communication method of claim 5, wherein the modem is selected from the group consisting of an asymmetric digital subscriber line (ADSL) modem, a symmetric digital subscriber line (SDSL) modem, and a cable modem.

7. The communication method of claim 5, wherein the VLAN ID identifies the corresponding LAN port of the modem.

8. The communication method of claim 5, wherein the client device is selected from the group consisting of a personal computer (PC), a network server, a hypertext transfer protocol (HTTP) server, and a file transfer protocol (FTP) server.

9. A storage medium having stored thereon instructions that, when executed by a modem, causing the modem to perform a communication method between a client device and a wide area network (WAN), the method comprising:
(a) receiving a communication data packet from the WAN or the client device;
(b) determining if the communication data packet contains a virtual local area network ID (VLAN ID);
(c) determining if the VLAN ID of the communication data packet identifies a local area network (LAN) port of the modem;
(d) transmitting the communication data packet containing the VLAN ID to the client device or the WAN using the LAN port of the modem in response to a determination that the VLAN ID of the communication data packet identifies the local area network (LAN) port of the modem;
(e) removing the VLAN ID of the communication data packet in response to the determination that the VLAN ID of the communication data packet does not identify a local area network (LAN) port of the modem;
(f) translating an Internet protocol (IP) address of the communication data packet having no VLAN ID; and
(g) transmitting the translated communication data packet to the client device or the WAN using a network access translation (NAT) port of the modem.

10. The medium of claim 9, wherein the modem is selected from the group consisting of an asymmetric digital subscriber line (ADSL) modem, a symmetric digital subscriber line (SDSL) modem, and a cable modem.

11. The medium of claim 9, wherein the VLAN ID identifies the LAN ports of the modem.

12. The medium of claim 9, wherein the client device is selected from the group consisting of a personal computer (PC), a network server, a hypertext transfer protocol (HTTP) server, and a file transfer protocol (FTP) server.
